(19) United States
(12) Patent Application Publication
(10) Pub. No.: US 2015/0067047 A1
(43) Pub. Date: Mar. 5, 2015

(54) PROVIDING A MEETING RULES TEMPLATE FOR A MEETING SERVICE IN A NETWORK ENVIRONMENT

(71) Applicant: CISCO TECHNOLOGY, INC., San Jose, CA (US)

(72) Inventors: Jiantao Fu, Hangzhou Zhejiang (CN); Saikun Wang, Hangzhou Zhejiang (CN); Jingdong Wang, Hangzhou Zhejiang (CN); Weifeng Shen, Hangzhou Zhejiang (CN)

(73) Assignee: CISCO TECHNOLOGY, INC., San Jose, CA (US)

(21) Appl. No.: 14/017,121

(22) Filed: Sep. 3, 2013

(51) Int. Cl. H04L 29/08

(52) U.S. Cl. CPC H04L 67/16
USPC 709/204

(57) ABSTRACT

A method is provided in one example and includes receiving a rules template associated with an online interactive activity by a network element. The rules template includes at least one rule for defining a manner in which a process of the online interactive activity is to be conducted. The method further includes parsing the rules template to determine the at least one rule, and controlling the process of the online interactive activity in accordance with the determined at least one rule.

### TECHNICAL FIELD

This disclosure relates in general to the field of communications and, more particularly, to providing a meeting rules template for a meeting service in a network environment.

### BACKGROUND

Online meeting services have become increasingly popular as a means to allow meeting participants to interact with one another without requiring the participants to be located in the same physical location. The meeting environment offered by existing online meeting services often produces freestyle unstructured meetings that lack efficiency. However, it is often desired that meetings follow a particular meeting style in which certain meeting structures and rules are used in an attempt to achieve more efficiency during the online meeting. In order to achieve such a meeting, a meeting host that is familiar with the rules and procedures of the particular style of meeting is required. In addition, the meeting host must proactively enforce the special rules and procedures of the meeting in order to obtain the desired result.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1 is a simplified block diagram of a communication system for providing a meeting rules template for a meeting service in a network environment;

FIG. 2 illustrates a simplified block diagram of an embodiment of a meeting server of FIG. 1;

FIG. 3 illustrates an embodiment of a meeting rules template;

FIG. 4 is a simplified flowchart illustrating one potential operation associated with the present disclosure for generating a meeting rules template;

FIG. 5 is a simplified flowchart illustrating another potential operation associated with the present disclosure for receiving a meeting rules template by a meeting services component of the meeting server;

FIG. 6 is a simplified flowchart illustrating another potential operation associated with the present disclosure for scheduling a meeting using a designated meeting rules template; and

FIG. 7 is a simplified flowchart illustrating another potential operation associated with the present disclosure for controlling a meeting using a designated meeting rules template.

### DETAILED DESCRIPTION OF EXAMPLE EMBODIMENTS

### Overview

A method is provided in one example and includes receiving a rules template associated with an online interactive activity by a network element. The online interactive activity can include any activity associated with network communications (e.g., an audio call, a conference call, a videoconference, a voice exchange, a simple data exchange, an email paradigm, etc.) Further, the rules template can include any type of framework, fill-in graphic, command architecture, model, rule system, database scheme, etc.). The rules template includes at least one rule for defining a manner in which a process of the online interactive activity is to be conducted. The method further includes parsing the rules template to determine the at least one rule, and controlling the process of the online interactive activity in accordance with the determined at least one rule. In more particular embodiments, the method further includes receiving a selection of the rules template from among a plurality of meeting rules templates. In more particular embodiments, the rules template includes a template identifier to identify the rules template from among the plurality of predefined rules templates.

### Example Embodiments

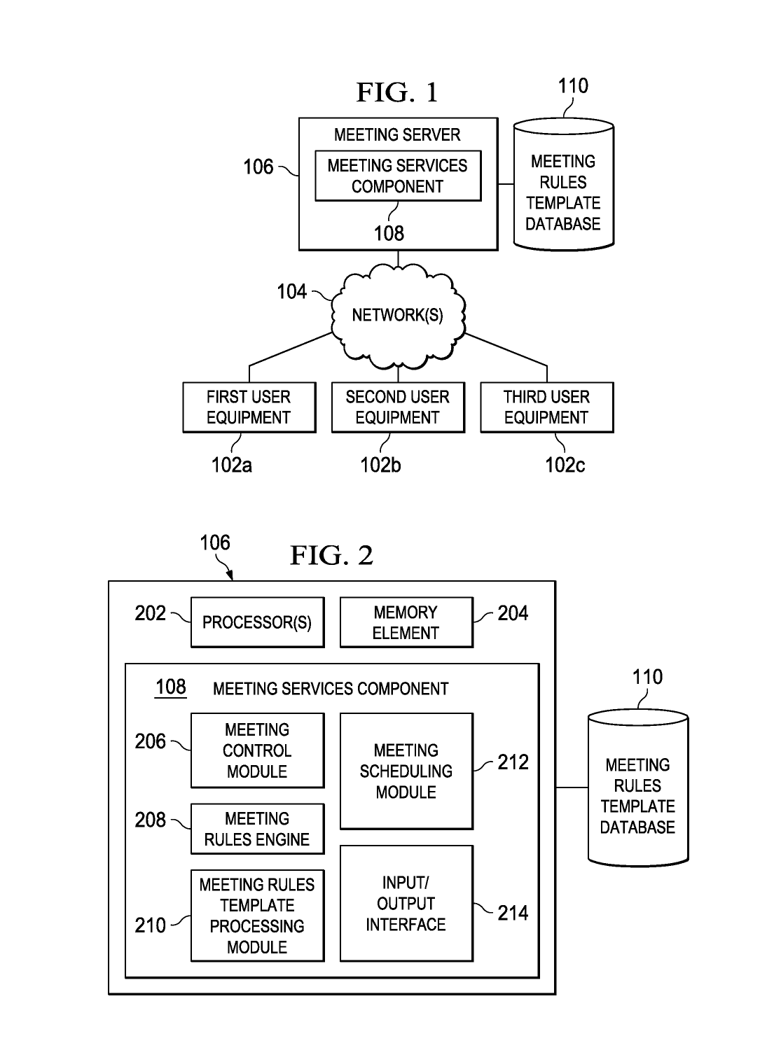

Referring to FIG. 1, FIG. 1 is a simplified block diagram of a communication system 100 for providing a meeting rules template for a meeting service in a network environment. FIG. 1 includes a first user equipment 102a, a second user equipment 102b, and a third user equipment 102c in communication with one or more networks 104. Communication system 100 further includes a meeting server 106 in communication with network(s) 104. Meeting server 106 includes a meeting services component 108. Meeting server 106 is in further communication with a meeting rules template database 110.

First user equipment 102a, second user equipment 102b, and third user equipment 102c may each include one or more devices configured to allow a user to participate in one or more meetings provided by meeting services component 108 of meeting server 106. In particular embodiments, first user equipment 102a, second user equipment 102b, and third user equipment 102c may each include one or more audio and/or video output devices to present audio and/or video content associated with a particular meeting, and one or more input devices such as a microphone, video camera, or a keyboard to allow the user to interact with other participants of the meeting.

Network(s) 104 represent a series of points or nodes of interconnected communication paths for receiving and transmitting packets of information that propagate through communication system 100. Network(s) 104 offer a communicative interface between sources and/or hosts, and may be any local area network (LAN), wireless local area network (WLAN), metropolitan area network (MAN), Intranet, Extranet, WAN, virtual private network (VPN), or any other appropriate architecture or system that facilitates communications in a network environment. Network(s) 104 may implement a UDP/IP connection and use a TCP/IP communication language protocol in particular embodiments of the present disclosure. However, network(s) 104 may alternatively implement any other suitable communication protocol for transmitting and receiving data packets within communication system 100.

Meeting services component 108 of meeting server 106 is configured to provide meeting services to one or more of first user equipment 102a, second user equipment 102b, and third user equipment 102c by communicating data associated with a meeting therebetween. Data, as used herein in this document, refers to any type of numeric, voice, video, media, or script data, or any type of source or object code, or any other suitable information in any appropriate format that may be communicated from one point to another. In one or more embodiments, meeting services component 108 is configured to receive a meeting rules template including definitions of rule associated with meeting, schedule a meeting that will use the meeting rules template during the course of the meeting, and provide the meeting service to meeting participants while implementing the meeting rules defined by the meeting rules template during the meeting as will be further described herein.

Current online meeting services provide meetings in which the content and the form of the meeting is essentially freestyle and give one or more user's full control of the meeting. For example, in a brain storm meeting there is typically no limitations regarding how the meeting is to be conducted. As a result, this kind of meeting may be inefficient if no rules are enforced. A brainstorming meeting typically requires special rules. Similarly, a plan meeting for software development also requires its own rules to achieve efficiency. Other meeting types such as online interviews, online examinations, online debate competitions require special usage scenarios require different rules that current online meetings are unable to provide effectively.

Current meeting systems are usually not efficient enough for above special usage scenarios. Even in a simple common free discussion meeting, if the moderator is not experienced enough to control and host the meeting, the meeting usually falls into disorder and few achievements can be made at the end. As a result, attendees of such unorganized meetings usually feel tired and depressed after this kind of meeting.

In addition, current meeting services allow basic information such as “when” a meeting will be held, “where” the meeting will be held, and “what” the meeting will be about. However, they do not allow the specification or implementation of “how” the meeting (or other interactive activity) will be carried out.

In accordance with various embodiments, a meeting rules template is used to enforce special rules for a specific meeting to enable the meeting to be more efficient. For example, the meeting rules template may be used to enforce rules such as “Six Thinking Hats” rules for a brainstorming session, and “stand-up meeting” rules for a software development meeting. In addition, rules may be implemented in other types of interactive activities beyond the scope of just online meetings such as online interviews, television shows (for example, singing competition programs) or games which require some form of rules to be enforced during the interactive activity. With such rules, these kinds of online interactive activities may be performed done more easily and less intrusively.

Various embodiments of the meeting rules template provide a common mechanism for users such as meeting service providers or meeting customers to add special rules to a meeting according to particular usage scenarios easily to enable the moderator or host of the meeting to control the process of the meeting and make it more efficient, convenient and productive. In one or more embodiments, the meeting rules template may provide guidance for online interactive activities in an extensible way (“extensible” here meaning that it can be easily used in different user scenarios), and lead the attendees regarding on how to interact correctly according to the rules and efficiently during the meeting.

Various embodiments provide for a common mechanism in the form of a meeting rules template for meeting service providers or meeting customers/users/participants to easily implement special rules to a meeting according to particular usage scenarios. thus it can help the moderator or host of the meeting to control the process of the meeting and make if more efficient, convenient and productive. In accordance with one or more embodiments, a meeting rules template provides a mechanism to define an extensible meeting process description template for online meetings or interactions in which users may fill the meeting rules template with rule definitions according to the desired meeting requirements, and upload the meeting rules template to meeting server 106 when scheduling the meeting or at runtime of the meeting to control the process of the meeting.

In a particular embodiment of a high-level workflow a meeting application programming interface (API) is exposed within meeting services component 108 in order to allow control of an online meeting process. In a particular example, the meeting may be divided into different phases, and each phase may have a different duration, attendees may speak in predefined order during the phase, and audio/video may be enabled/disabled for attendees during the phase. All such operations can be controlled by exposing the meeting API. A user may define the rules of the meeting rules template of the online meeting according to the user's special requirements for the meeting, or may alternately use an existing predefined meeting rules template. The meeting rules template defines rules indicating how meeting services component 108 will control the meeting process. In a particular embodiment, the rules of the meeting rules template are defined using extensible formats such as Extensible Markup Language (XML) and JavaScript Object Notation (JSON). The user may then schedule an online meeting, and choose the meeting rules template to use for the particular meeting. Meeting services component 108 may then parse the rules defined by the meeting rules template, which describe the meeting process. Meeting services component 108 may then apply the rules for the meeting via the exposed API.

FIG. 2 illustrates a simplified block diagram of an embodiment of meeting server 106 of FIG. 1. Meeting server 106 includes processor(s) 202, memory element 204, and meeting services component 108. Meeting server 106 is in further communication with a meeting rules template database 110. Meeting rules template database 110 is configured to store one or more meeting rules templates, which may be selected by a user in order to control the process of a particular meeting scheduled by the user.

Processor(s) 202 is configured to execute various tasks of meeting server 106 as described herein and memory element 204 is configured to store data associated with meeting server 106. Meeting services component 108 includes meeting control module 206, meeting rules engine 208, meeting rules template processing module 210, meeting scheduling module 212, and input/output (I/O) interface 214. Meeting control module 206 is configured to control the process of a meeting in accordance with the meeting rules defined within the meeting rules template. Meeting rules engine 208 is configured to execute the meeting rules defined by the meeting rules template and indicate to the meeting control module 206 how the meeting should be controlled in accordance with the meeting rules. Meeting rules template processing module 210 is configured to receive a particular meeting rules template from meeting rules template database 110, parse the meeting rules template to determine the meeting rules, and provide the meeting rules to meeting rules engine 208. Meeting scheduling module 212 is configured to receive a request from a user for scheduling a particular meeting, at a particular date/time, including particular participants, and using meeting rules defined by a particular meeting rules template. I/O interface(s) 214 is configured to receive communications from and send communications to other devices or software modules such as first user equipment 102a, second user equipment 102b, and/or third user equipment 102c.

In one implementation, meeting server 106 is a network element that includes software to achieve (or to foster) the meeting service operations as outlined herein in this Specification. Note that in one example, each of these elements can have an internal structure (e.g., a processor, a memory element, etc.) to facilitate some of the operations described herein. In other embodiments, these meeting service operations may be executed externally to this element, or included in some other network element to achieve this intended functionality. Alternatively, meeting service 106 may include software (or reciprocating software) that can coordinate with other network elements in order to achieve the operations, as outlined herein. In still other embodiments, one or several devices may include any suitable algorithms, hardware, software, components, modules, interfaces, or objects that facilitate the operations thereof. As used herein in this Specification, the term ‘network element’ is meant to encompass routers, switches, gateways, bridges, loadbalancers, firewalls, inline service nodes, proxies, servers, processors, modules, or any other suitable device, component, element, proprietary appliance, or object operable to exchange information in a network environment. This network element may include any suitable hardware, software, components, modules, interfaces, or objects that facilitate the operations thereof. This may be inclusive of appropriate algorithms and communication protocols that allow for the effective exchange of data or information.

Examples of uses cases of online interactions in which it may be desirable to enforce rules include, but are not limited to, online meetings, online interviews, entertainment such as singing competitions or video games. In an online meeting, assume that a user wants to hold a brainstorming meeting with several participants using a “Six Thinking Hats” meeting procedure. In a “Six Thinking Hats” meeting methodology, the meeting is broken up into six different phases—Information: (White)—considering purely what information is available, what are the facts?; Emotions (Red)—intuitive or instinctive gut reactions or statements of emotional feeling (but not any justification); Discernment (Black)—logic applied to identifying reasons to be cautious and conservative; Optimistic response (Yellow)—logic applied to identifying benefits, seeking harmony; Creativity (Green)—statements of provocation and investigation, seeing where a thought goes; and Agreement (Blue) the group evaluates the outcomes decides what they should do next.

Since a meeting participant may not be familiar with such process, the meeting rules template may define tips, which may be displayed as a popup on a graphical user interface (GUI) screen of the participants to guide the attendees through the process. The meeting rules template may be further defined to divide the meeting into several phases with each phase having its meeting rules such as its own focus and/or time limits. In addition, the meeting rules template may be defined to enforce a turn for the attendees/participants to speak out or otherwise convey their ideas. In particular embodiments, the meeting rules template further include one or more definitions to cause meeting services component 108 to conduct polling of the meeting attendees/participants. Other kinds of meetings, such as “weekly meeting” or “stand-up meeting” may also be defined using a meeting rules template.

In an online interview, the interview may be divided into several parts in a similar manner as an online meeting by defining a phase within the meeting rules template for each part of the meeting. In particular embodiments, an online interview use case may further include a meeting rules template, which includes definitions indicating that meeting services component 108 is to conduct one or more online examinations of participants during the online meeting. In a particular entertainment use case in which a television show includes a singing competition, a meeting rules template may be defined such that during an online audition each candidate may be given a chance to show his or her talents in a blind audition process, which enforces that the judges should not see the candidates. In such an example, video of the candidate may be automatically turned off during that phase of the competition by including a definition to this effect within the meeting rules template. In a video game use case, a meeting rules template may be defined to turn off video during a particular portion of a video game according to the rules of the video game.

A number of different rules for a meeting may be defined within a particular meeting rules template for a particular use case. In one embodiment, rules may specify the phase of the process including a focus, a time limit, and an autoswitch parameter. The phase rule indicates that a particular phase of a meeting is being defined. The focus rule may include a description of the intended focus of the current phase of the meeting which may be presented in a graphical user interface (GUI) of meeting software of the participants/attendees of the meeting in order to guide them on the intended focus of the current phase, and the time limit rule may specify that the phase is to last for a predetermined duration. The autoswitch parameter may be defined to determine whether the meeting will proceed to the next phase at the expiration of the predetermined duration. For example, a setting of disabling autoswitch may indicate that when the predetermined time duration is overdue, that it is up to the moderator to decide whether or not to proceed on to the next phase whereas enabling autoswitch may indicate that the meeting will be automatically switched to the next phase when the predetermined time duration been exceeded.

In some embodiments, a tips rule may be used to provide tips to the attendees in the GUI of meeting software to guide the attendees through the process of the current phase. In still other embodiments, one or more rules may be defined within the meeting rules template to integrate other activities such as online examinations and online polling activities with the meeting. In still other embodiments, meeting rules may be defined to indicate the order or turn in which attendees will speak or otherwise present information during the meeting or the current phase of the meeting and/or meeting rules to define a time limit for each attendees turn. In still other embodiments, meeting rules may be defined to disable and/or enable audio and/or video capabilities associated with an attendee at specific time. For example, in a particular embodiment a microphone of an attendee may be selectively disabled or enabled during the meeting.

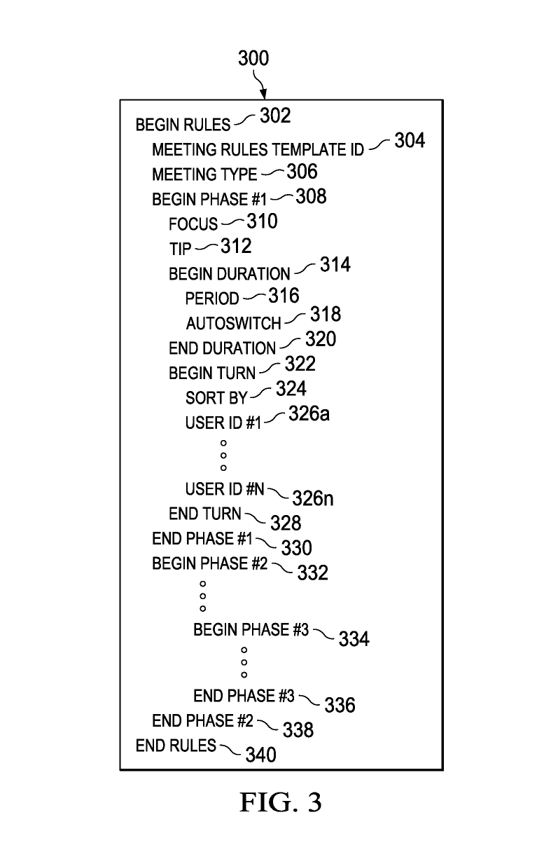

FIG. 3 illustrates an embodiment of a meeting rules template 300. The meeting rules template includes a “begin rules” designation 302 to indicate that meeting rule template 300 includes meeting rule definitions that are to follow. Meeting rules template 300 further includes a meeting rules template identifier (ID) 304 that will be used for identifying the particular meeting rules template 300 among one or more meeting rules templates stored within meeting rules template database 110, and a meeting type definition 306 indicating the type of meeting defined by meeting rules template 300. For example, in particular embodiments, the meeting type definition 306 may indicate that the meeting type for meeting rules template 300 is a “brain storm” or “scrum plan meeting.”

Meeting rules template 300 further includes a begin phase #1 designator 308 designating the beginning of the definition of rules of a first phase of the meeting defined by meeting rules template 300, a focus definition 310 that includes a high level textual description, such as a title, of the expected focus of this phase of the meeting, and a tips definition including a detailed textual description of tips, hints and/or guidelines to provide guidance regarding how the current phase of the meeting is to be conducted.

Meeting rules template 300 further includes a “begin duration” designation 314 to indicate that duration rules associated with the present phase are to follow, a period definition 316 indicating a time duration of the currents phase, and an autoswitch parameter 318 indicating whether the current phase will switch to the next phase automatically after the expiration of the time duration or whether a moderator will decide whether the meeting will continue to the next phase. Meeting rules template 300 further includes an “end duration” designation 320 indicating that the duration rules definitions are at an end.

Meeting rules template 300 further includes a “begin turn” designation 322 indicating that turn rules associated with the present phase that define the order in which attendees will take turns in presenting information during the meeting. Meeting rules template 300 further includes a sort by definition 324, which defines a rule for when a user will speak or otherwise present information during a meeting. In a particular example, sortby definition 324 may define a rule in which attendees will take turns during the meeting in alphabetical order. Meeting rules template 300 may further include one or more user identifiers (IDs) 326a-326n which are associated with attendees of the meeting that are to be provided a turn to present information during the meeting. Meeting rules template 300 further include an “end turn” designation 328 indicating that the turn rules definitions are at an end.

Meeting rules template 300 may further include one or more additional phases, which will be defined within the meeting rules template. In addition, the phases may be divided into subphases, which may each have their own defined meeting rules. For example, in the embodiment of FIG. 3 meeting rules template 300 includes a second “begin phase” designation 332 to begin definition of a second phase of the meeting and third “begin phase” designation 334 nested within the second phase beginning definition of a third phase of the meeting. Meeting rules template 3003 further includes a third “end phase” designation 336 indicating the end of meeting rules definitions for the third phase of the meeting, and a second “end phase” designation 338 indicating the end of meeting rules definitions for the second phase of the meeting. Meeting rules template 300 further includes an “end rules” designation 340 indicating that the meeting rules definitions for the meeting have ended.

In a particular embodiment, the meeting rules of meeting rules template 300 may be defined using an extensible format such as XML or JSON. In one or more embodiments, the use of an extensible format allows for new meeting rules to be easily added. An example XML schema for meeting rule definitions for meeting rules template 300 is as follows:

```
Schema
################
<?xml version=“1.0”?>
<xs:schema xmlns:xs=“http://www.w3.org/2001/XMLSchema”>
<!-- Define the meeting rules of template, the rules gives hint and guidelines
about how the meeting is carried on --> <xs:element name=“rules”>
<xs:complexType>
<!-- The type of template, for example, Brain storm or Scrume meeting -->
<xs:element name=“type” type=“xs:string”/>
<!-- The meeting template id which identify the meeting rules template -->
<xs:element name=“id” type=“xs:string”/>
<!-- Define the rules for each phase of the meeting --> <xs:element
name=“phase” type=“phaseType”></xs:element>
<xs:complexType name=“phaseType”>
<!-- on/off video when is someone's turn -->
<xs:attribute name=“video” type=“xs:boolean”/>
<!-- on/off audio when is someone's turn --> <xs:attribute name=“audio”
type=“xs:boolean”/>
<!-- What will this phase focus on, high level description title -->
<xs:element name=“focus” type=“xs:string”/>
<!-- Give some tips on how to carry on the meeting in the following
steps, detailed description --> <xs:element name=“tips” type=“xs:string”/>
<!-- the duration of each phase in seconds -->
<xs:element name=“duration” type=“durationType”></xs:element>
<xs:complexType name=“durationType”>
<!-- How long will this phase going on or how long each attendee
speaks --> <xs:element name=“period” type=“xs:integer”/>
<!-- Whether to switch to the next phase automatically when the time
duration is over. When the duration is about to over, it can give out some
tips (examples, show the remaining times) on the user interface, and let the
moderator decide whether to switch to the next phase -->
<xs:element name=“autoswitch” type=“xs:boolean”/>
<xs:complexType>
<!-- In which turn the attendees talks, it can include alphabetical,
joined turn or specified -->
<xs:element name=“turn”>
<xs:complexType>
      <!-- sort by which order -->
      <xs:element name=“sortby”>
<xs:simpleType>
<xs:restriction base=“xs:string”>
<xs:enumeration value=“Alphabet”/>
<xs:enumeration value=“Join”/>
<!-- List means use the default order listed in user element -->
<xs:enumeration value=“List”/>
</xs:restriction> </xs:simpleType> </xs:element>
<!-- which users are selected -->
<xs:element name=“user”>
<xs:complexType>
<!-- id of user -->
<xs:attribute name=“userid” type=“xs:string”/>
<!-- specify audio/video for specific user, will override the same
attributes of the phase - -> <xs:attribute name=“video”
type=“xs:boolean”/>
<xs:attribute name=“audio” type=“xs:boolean”/>
<!-- specify duration for each user -->
<xs:element name=“duration” type=“durationType”></xs:element>
</xs:complexType>
</xs:element>
</xs:complexType>
</xs:element>
<!--Recursive phase-->
<xs:element name=“phase” type=“phaseType”></xs:element>
</xs:complexType> </xs:complexType>
</xs:element>
</xs:schema>
```

An example of meeting rules template 300 to define a Six Thinking Hat meeting is as follows:

###########
Six thinking hat
<rules>
<id>Six Thinking Hats</id>
<type>Brain storm</type>
<phase>
<focus>Information(White hat)</focus>
<tips>considering purely what information is available,
what are the facts?</tips>
<phase>
<focus>Problem state</focus>
<duration>
<period>180</period>
<autoswitch>false</autoswitch>
</duration>
</phase> <phase> <focus>Speaking in turn</focus>
<duration>
<period>720</period>
<autoswitch>false</autoswitch>
</duration>
<turn>
<sortby>Alphabet</sortby>
<user userid=‘user_a’>
<duration>
<period>120</period>
<autoswitch>false</autoswitch>
</duration>
</user>
<user userid=‘user_b’/>
<user userid=‘user_c’/>
</turn> </phase> </phase> <phase> <focus>Emotions(Red hat)</
focus>
<tips>instinctive gut reaction or statements of emotional feeling</tips>
<phase>
<focus>Problem state</focus>
<period>3min</period> </phase>
<phase>
<focus>Speaking in turn</focus>
<duration>
<period>720</period> <autoswitch>false</autoswitch>
</duration>
<turn>
<user userid=‘user_a’/> <user userid=‘user_b’/> <user
userid=‘user_c’/> </turn>
</phase>
</phase>
</rules>

An example of meeting rules template 300 to define a scrum plan meeting is as follows:

<rules>
<id>scrum plan meeting</id>
<type>agile meeting</type>
<phase>
<focus>Decide Your Sprint Duration</focus>
<tips>The optimum Sprint duration depends on many factors.
The range is between 1 week and 1 month. A development team's
“cycle time” is a direct reflection of the
maturity of their processes.</tips>
</phase>
<phase>
<focus>Select Target Backlog for Sprint</focus>
<tips>Looking at the top section of the Product Backlog, what
would seem to be a reasonable goal to set for the Sprint? </tips>
</phase>
<phase>
<focus>Clarify Sprint Requirements</focus>
<tips>Take each item on the Product Backlog. It's important to go
through them methodically, one item at a time. The Product
Owner presents each item and explains how he/she sees
it working from a functional perspective. The whole team discusses
the item in detail.</tips>
</phase>
<phase>
<focus>Set the Sprint Budget</focus>
<tips>First of all, calculate the team???s Sprint Budget. This is the
available number of hours the team has to work on the Sprint.</tips>
</phase> <phase>
<focus>Break Requirements into Tasks</focus>
<tips>Go through each Product Backlog item selected for the Sprint.
Break the requirements into tasks. Each of these tasks, especially
development, may be broken down further.</tips>
</phase>
<phase>
<focus>Estimate Tasks in Hours</focus>
<tips>Keep tasks small. Estimate all tasks in hours. Estimate each
task as a team.</tips>
</phase>
<phase>
<focus>Commit to the Sprint Backlog</focus>
<tips>Add up all the task estimates for the selected Product Backlog.
If they are significantly over the team's Sprint Budget, reduce the
number of Product Backlog items selected for the Sprint. </tips>
</phase>
</rules>

In a particular embodiment, once the description of the meeting rules is defined within meeting rules template 300, an API is exposed within meeting services component 108 for the rules to allow meeting services component 108 to control the process of the meeting by parsing the meeting rules within meeting rules template 300 and calling the API to enforce the meeting rules for the process of the meeting. Accordingly, in various embodiments meeting rules may be added to meeting rules template 300 for defining how or a manner in which a process of a meeting or other online interactive activity is to proceed and an API may be exposed to enforce the meeting rules for the process of the online interactive activity.

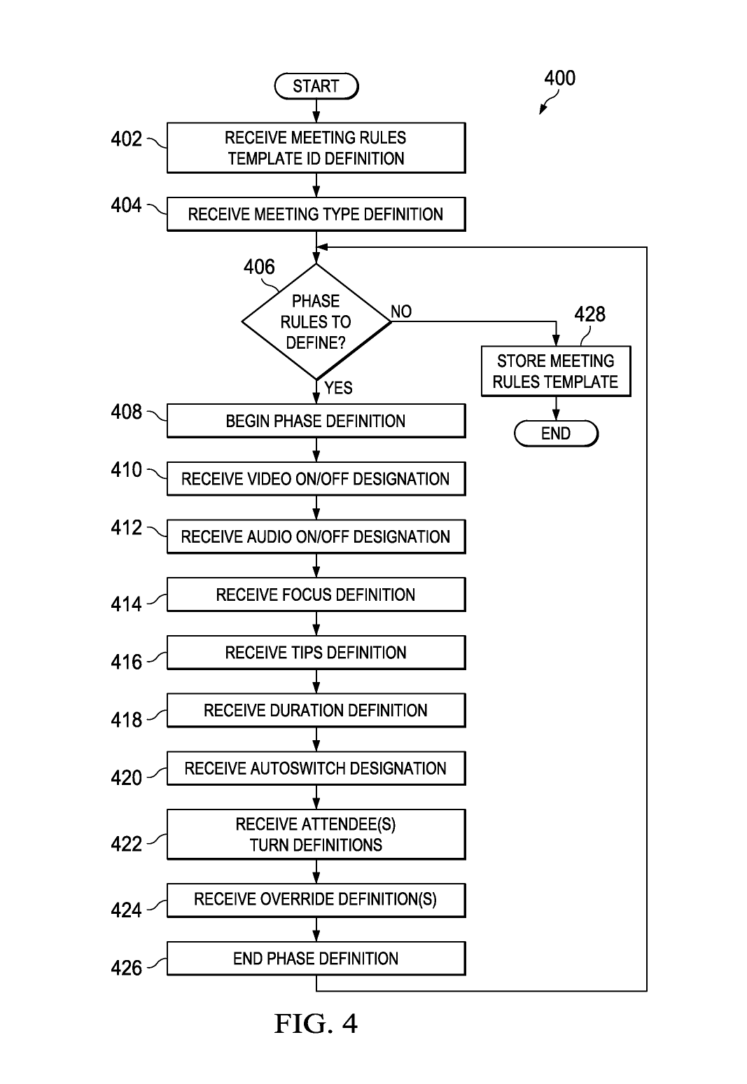

FIG. 4 is a simplified flowchart 400 illustrating one potential operation associated with the present disclosure for generating a meeting rules template. In one embodiment, a user may define a meeting rules template via a user interface of user equipment 102a. In a particular embodiment, the user may generate a meeting rules template using a document editor configured on particular user equipment 102a-102c. In 402, user equipment 102a receives a meeting rules template identifier (ID) for the meeting from the user. In 404, user equipment 102a receives a meeting type definition from the user. In 406, it is determined whether there are any remaining phase rules associated with a phase of the meeting to be defined. If there are phase rules to be defined, a begin phase definition is received in 408. In 410, a video on/off designation is received indicating whether video input is to be enabled for one or more attendees of the meeting. In 412, an audio on/off designation is received indicating whether audio input is to be enabled for one or more participants of the meeting.

In 414, a focus definition for the current phase is received. In 416, a tips definition for the current phase is received. In 418, a duration definition for the current phase is received. In 420, an autoswitch designation is received for the current phase. In 422, attendee turn definitions are received for one or more attendees of the meeting indicating the order in which the one or more participants are to present information during the current phase. In 424, any override definitions are received if it is desired to override one or more previously designated meeting rules associated with the phase. In 426, a designation to end the current phase definitions is received and the operations return to 406 in which it is determined whether there are any additional phase definitions required within the meeting rules template.

In 428, the completed meeting rules template is stored. In one embodiment, the meeting rules template is stored within memory of user equipment 102a. In still other embodiments, the meeting rules template is sent to meeting server 106 and stored within meeting rules template database 110. The operations then end.

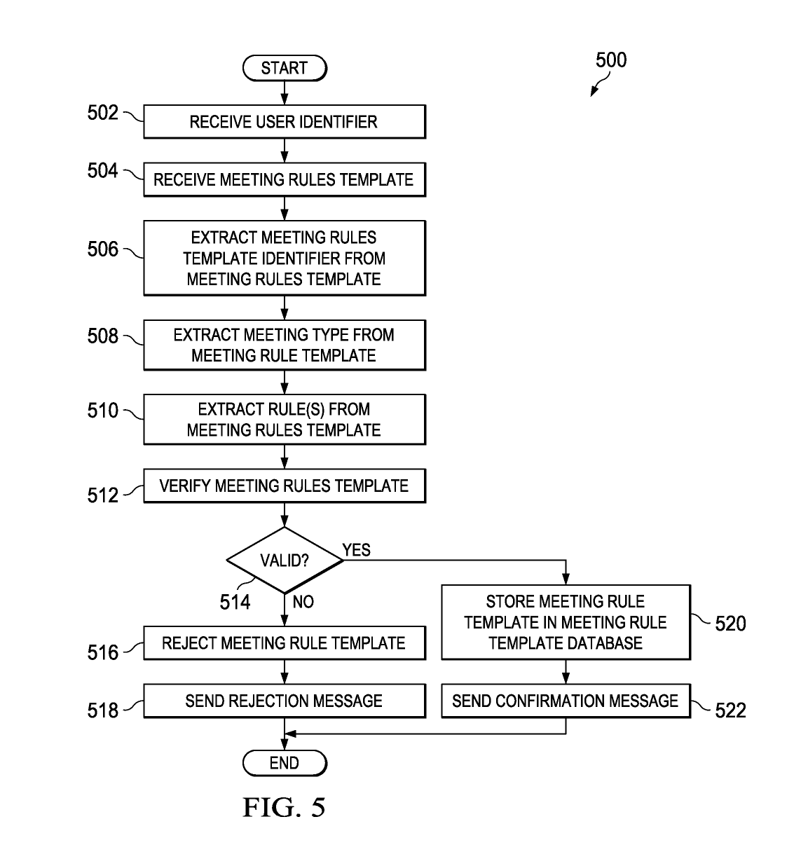

FIG. 5 is a simplified flowchart 500 illustrating another potential operation associated with the present disclosure for receiving a meeting rules template by meeting services component 108 of meeting server 106. In 502, meeting services component 108 receives a user identifier from user equipment 102a associated with a user that wishes to provide a meeting rules template for an online meeting. In 504, meeting services component 108 receives a meeting rules template. In 506, meeting services component 108 extracts the meeting rules template identifier from the meeting rules template. In 508, meeting services component 108 extracts the meeting type from the meeting rules template. In 510, meeting services component 108 extracts one or more meeting rules from the meeting rules template, which define the manner in which a meeting defined by the meeting rules template will be conducted. For example, the meeting rules may include any one or more of the meeting rules discussed herein such as phase definitions, focus definitions, tip definitions, user turn definitions, and audio/video permission definitions. In 512, meeting services component 108 verifies the meeting rules template to determine whether the rule definitions contained therein are valid and/or meet any required syntax. In 514, meeting services component 108 determines whether the meeting rules template is valid based upon the verification.

If the meeting rules template is determined to be not valid in 514, the operations continue to 516 in which meeting services component 108 rejects the meeting rules template. In 518, meeting services component 518 sends a rejection message to user equipment 102a indicating that the meeting rules template has been rejected and the operations end. In particular embodiments, the rejection message may include an indication of why the meeting rules template was rejected.

If the meeting rules template is determined to be valid in 514, the operations continue to 520 in which the meeting rules template is stored in meeting rules template database in associations with the meeting rules template identifier. In some embodiments, the meeting rules template may be further stored in association with the user identifier so that a user may more easily choose a meeting rules template that he or she has previously defined and/or to limit scheduling of a meeting by a user to a template to which that user is authorized to access. In 522, meeting rules component 108 sends a confirmation message to user equipment 102a indicating that the meeting rules template has been accepted and the operations end.

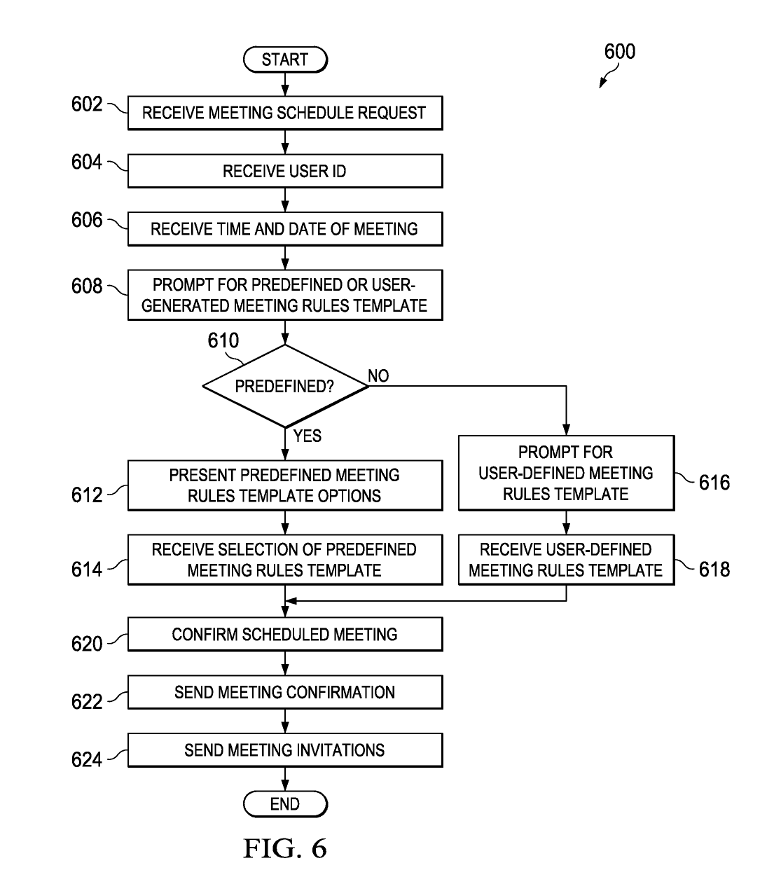

FIG. 6 is a simplified flowchart 600 illustrating another potential operation associated with the present disclosure for scheduling a meeting using a designated meeting rules template. In 602, meeting services component 108 receives a meeting schedule request from a user. In a particular embodiment, the meeting schedule request may be received from user equipment 102a. In 604, meeting services component 108 receives a user identifier (ID) from the user. In 606, meeting services component 108 receives an intended time and date of the meeting from the user. In 609, meeting services component 108 prompts the user to choose either a predefined meeting rules template or a user-generating meeting rules template. In 610, meeting services component 108 determines whether the user selected a predefined meeting rules template or a user-generated meeting rules template.

If it is determined that the user selected a predefined meeting rules template, the operations continue to 612. In 612, meeting services component 108 presents one or more predefined meeting rules template options to the user. Each of the predefined meeting rules templates includes meeting rules configured to implement a particular meeting type during an online interactive activity such as a meeting. For example, the user may be presented with a choice of meeting rules templates that including meeting rules templates including rules configured to implement a “brain storm” or “scrum plan meeting.” In 614, meeting services component 108 receives a selection of one of the predefined meeting rules templates from the user. The operations then continue to 620.

If it is determined that the user did not select a predefined meeting rules template, the operations continue to 616. In 616, meeting services component 108 prompts the user for a user-defined meeting rules template. In 618, meeting services component 108 receives the user-defined meetings rules template. In some embodiments, the user-defined meeting rules template may be provided by the user prior to the sending of the meeting schedule request. The operations then continue to 620.

In 620, meeting services component 108 confirms the scheduled meeting. In 622, meeting services component 108 sends a meeting confirmation to the user providing an indication that the requested meeting has been scheduled and the requested meeting will use the selected meeting rules template. In 624, meeting services component sends meeting invitations to each of the meeting attendees. In at least one embodiment, the meeting attendees are provided within the meeting rules template. In still other embodiments, the meeting attendees may be provided by the user in response to a prompt from meeting services component 108. The operations then end.

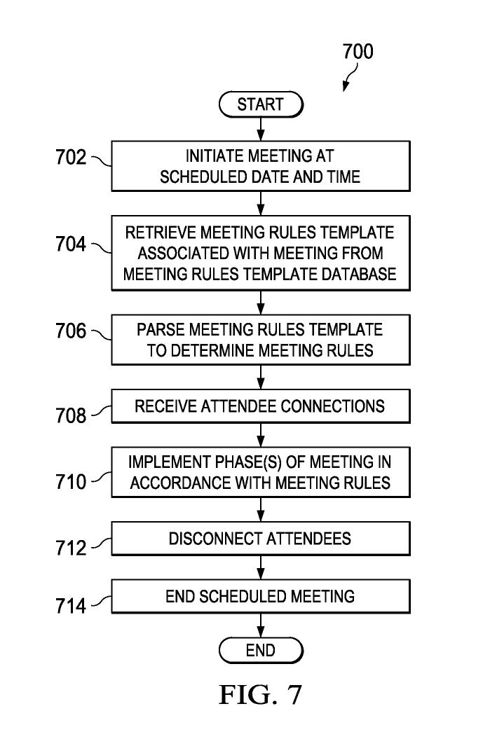

FIG. 7 is a simplified flowchart 700 illustrating another potential operation associated with the present disclosure for controlling a meeting using a designated meeting rules template. In 702, meeting services component 108 initiates a meeting at a scheduled date and time. In 704, meeting services component 108 retrieves the meeting rules template associated with the meeting from meeting rules template database 110. In 706, meeting services component 108 parses the meeting rules template to determine the meeting rules that will be used to implement/control the process of the scheduled meeting. In 708, meeting services component 108 receives attendee connections from each of the attendees of the meeting in order to join the attendees to the meeting. In 710, meeting services component 108 implements one or more phases of the meeting in accordance with the determined meeting rules. In a particular example, meeting services component 108 may display focus and tips to the attendees for the particular phase of the meeting as defined by the meeting rules template. In another example, meeting services component 108 may control the order and/or the duration of the presentation of information for each attendees during the meeting as defined by the meeting rules template. In still another example, meeting services component 108 may control the duration of each phase of the meeting as defined by the meeting rules template.

In 712, meeting services component 108 disconnects the attendees from the meeting after the predetermined time for the meeting has passed and/or when a moderator/presenter of the meeting ends the meeting. In 714, meeting services component 108 ends the scheduled meeting. The operations then end.

Various embodiments may provide one or more advantage. One advantage that may be provided by one embodiment is to add more value for online meetings because the meeting rules template allows the online meeting to be more efficient by allowing the enforcing of specific rules for a specific meeting. For example, the meeting rules template may be used to enforce “Six Thinking hats” rules for a brain storming session or “Standup meeting” rules for a software development meeting.

Another advantage that may be offered by one embodiments includes the implementation of user-friendly rules and meeting behaviors according to those rules to make attendees experience a better meeting environment than one controlled by an inexperienced host. Further, an efficient and productive meeting may make attendees happier at the end of the meeting.

Another advantage that may be offered by one embodiment is that a meeting rules template may extend the market for online interactive services by allowing the providing of more than just an online meeting including online training, online sales, online interviews, online games, online talent shows, and many other online interactive activities.

Still another advantage that may be offered by one embodiment is that of providing an extensible mechanism to allow a user such as a meeting service provider or customer, to define his or her own meeting rules template according to the user's specific use case and share the meeting rules template with others to use in their own meetings.

Note that in certain example implementations, the meeting services functions outlined herein may be implemented by logic encoded in one or more tangible media (e.g., embedded logic provided in an application specific integrated circuit [ASIC], digital signal processor [DSP] instructions, software [potentially inclusive of object code and source code] to be executed by a processor, or other similar machine, etc.). In some of these instances, a memory element [as shown in FIG. 2] can store data used for the operations described herein. This includes the memory element being able to store software, logic, code, or processor instructions that are executed to carry out the activities described in this Specification. A processor can execute any type of instructions associated with the data to achieve the operations detailed herein in this Specification. In one example, the processor [as shown in FIG. 2] could transform an element or an article (e.g., data) from one state or thing to another state or thing. In another example, the activities outlined herein may be implemented with fixed logic or programmable logic (e.g., software/computer instructions executed by a processor) and the elements identified herein could be some type of a programmable processor, programmable digital logic (e.g., a field programmable gate array [FPGA], an erasable programmable read only memory (EPROM), an electrically erasable programmable ROM (EEPROM)) or an ASIC that includes digital logic, software, code, electronic instructions, or any suitable combination thereof.

In one example implementation, Meeting server 106 may include software in order to achieve the meeting services functions outlined herein. These activities may be facilitated by meeting control module 206, meeting rules engine 208, meeting rules template processing module 210, meeting scheduling module 212, and/or input/output interface 214 (where these modules can be suitably combined in any appropriate manner, which may be based on particular configuration and/or provisioning needs). Meeting server 106 may include memory elements for storing information to be used in achieving the intelligent forwarding determination activities, as discussed herein. Additionally, meeting server 106 may include a processor that can execute software or an algorithm to perform the meeting services operations, as disclosed in this Specification. These devices may further keep information in any suitable memory element [random access memory (RAM), ROM, EPROM, EEPROM, ASIC, etc.], software, hardware, or in any other suitable component, device, element, or object where appropriate and based on particular needs. Any of the memory items discussed herein (e.g., database, tables, trees, cache, etc.) should be construed as being encompassed within the broad term ‘memory element.’ Similarly, any of the potential processing elements, modules, and machines described in this Specification should be construed as being encompassed within the broad term ‘processor.’ Each of the network elements can also include suitable interfaces for receiving, transmitting, and/or otherwise communicating data or information in a network environment.

Note that with the example provided above, as well as numerous other examples provided herein, interaction may be described in terms of two, three, or four network elements. However, this has been done for purposes of clarity and example only. In certain cases, it may be easier to describe one or more of the functionalities of a given set of flows by only referencing a limited number of network elements. It should be appreciated that communication system 100 (and its teachings) are readily scalable and can accommodate a large number of components, as well as more complicated/sophisticated arrangements and configurations. Accordingly, the examples provided should not limit the scope or inhibit the broad teachings of communication system 100 as potentially applied to a myriad of other architectures.

It is also important to note that the steps in the preceding flow diagrams illustrate only some of the possible signaling scenarios and patterns that may be executed by, or within, communication system 100. Some of these steps may be deleted or removed where appropriate, or these steps may be modified or changed considerably without departing from the scope of the present disclosure. In addition, a number of these operations have been described as being executed concurrently with, or in parallel to, one or more additional operations. However, the timing of these operations may be altered considerably. The preceding operational flows have been offered for purposes of example and discussion. Substantial flexibility is provided by communication system 100 in that any suitable arrangements, chronologies, configurations, and timing mechanisms may be provided without departing from the teachings of the present disclosure.

Although the present disclosure has been described in detail with reference to particular arrangements and configurations, these example configurations and arrangements may be changed significantly without departing from the scope of the present disclosure. Additionally, although communication system 100 has been illustrated with reference to particular elements and operations that facilitate the communication process, these elements and operations may be replaced by any suitable architecture or process that achieves the intended functionality of communication system 100.

What is claimed is:

1. A method, comprising:
receiving a rules template associated with an online interactive activity by a network element, the rules template including at least one rule for defining a manner in which a process of the online interactive activity is to be conducted;
parsing the rules template to determine the at least one rule; and
controlling the process of the online interactive activity in accordance with the determined at least one rule.

2. The method of claim 1, further comprising receiving a selection of the rules template from among a plurality of meeting rules templates.

3. The method of claim 2, wherein the rules template includes a template identifier to identify the rules template from among the plurality of predefined rules templates.

4. The method of claim 1, wherein the rule template includes a meeting type definition of the online interactive activity.

5. The method of claim 1, wherein the rules template includes a definition of at least one phase of the online interactive activity, wherein the at least one phase includes at least one rule associated with the at least one phase.

6. The method of claim 1, wherein the at least one rule defines an order in which attendees of the online interactive activity are to present information during the duration of the online meeting.

7. The method of claim 1, wherein the at least one rule includes a focus definition of a phase of the online interactive activity, the focus definition including a textual description of an expected focus of the phase of the online interactive activity.

8. The method of claim 7, further comprising displaying the textual description within a graphical user interface of a device associated with an attendee of the online interactive activity.

9. The method of claim 1, wherein the at least one rule includes a tips definition of a phase of the online interactive activity, the tips definition including a textual description to provide guidance to attendees of the online interactive activity regarding a manner in which the phase of the online interactive activity is to be conducted.

10. The method of claim 1, wherein the at least one rule includes a duration definition of a phase of the online interactive activity, the duration definition including a predefined time duration of the phase.

11. The method of claim 10, wherein the at least one rule further includes a designation that the online interactive activity is to automatically proceed to a subsequent phase of the online interactive activity after the predefined time duration of the phase has been exceeded.

12. The method of claim 1, wherein the at least one rule further includes a designation indicating whether video input or audio input is to be enabled for one or more attendees of the online interactive activity.

13. The method of claim 1, further comprising receiving the rules template from a database.

14. The method of claim 1, wherein the at least one rule is defined using an extensible format.

15. Logic encoded in one or more tangible media that includes code for execution and when executed by a processor operable to perform operations comprising:
receiving a rules template associated with an online interactive activity by a network element, the rules template including at least one rule for defining a manner in which a process of the online interactive activity is to be conducted;
parsing the rules template to determine the at least one rule; and
controlling the process of the online interactive activity in accordance with the determined at least one rule.

16. The logic of claim 15, wherein the operations further comprise:
receiving a selection of the rules template from among a plurality of meeting rules templates.

17. The logic of claim 16, wherein the rules template includes a template identifier to identify the rules template from among the plurality of predefined rules templates.

18. The logic of claim 15, wherein the rules template includes a definition of at least one phase of the online interactive activity, wherein the at least one phase includes at least one rule associated with the at least one phase.

19. An apparatus, comprising:
a memory element configured to store data,
a processor operable to execute instructions associated with the data, and
a meeting services component, the apparatus being configured to:
receive a rules template associated with an online interactive activity, the rules template including at least one rule for defining a manner in which a process of the online interactive activity is to be conducted;
parse the rules template to determine the at least one rule; and
control the process of the online interactive activity in accordance with the determined at least one rule.

20. The apparatus of claim 19, wherein the apparatus is further configured to receive a selection of the rules template from among a plurality of meeting rules templates.

21. The apparatus of claim 20, wherein the rules template includes a template identifier to identify the rules template from among the plurality of predefined rules templates.

22. The apparatus of claim 19, wherein the rules template includes a definition of at least one phase of the online interactive activity, wherein the at least one phase includes at least one rule associated with the at least one phase.
